(19) United States
(12) Patent Application Publication
(10) Pub. No.: US 2026/0119497 A1
(43) Pub. Date: Apr. 30, 2026

(54) LATENCY MANAGEMENT FOR MULTI-TENANT DATABASE SYSTEMS

(71) Applicant: BOARD OF REGENTS, THE UNIVERSITY OF TEXAS SYSTEM, Austin, TX (US)

(72) Inventors: Ning LI, Arlington, TX (US); Hong JIANG, Southlake, TX (US); Hao CHE, Plano, TX (US); Zhijun WANG, Plano, TX (US); Minh Q. NGUYEN, Ho Chi Minh City (VN); Todd ROSENKRANTZ, Benbrook, TX (US)

(73) Assignee: BOARD OF REGENTS, THE UNIVERSITY OF TEXAS SYSTEM, Austin, TX (US)

(21) Appl. No.: 19/369,853

(22) Filed: Oct. 27, 2025

Related U.S. Application Data
(60) Provisional application No. 63/712,635, filed on Oct. 28, 2024.

(51) Int. Cl. G06F 16/2453

(52) U.S. Cl. CPC G06F 16/24545

(57) ABSTRACT

A latency-oriented Service Level Optimization system for multi-tenant databases. Latency's negative effect on Quality of Service is expressed in terms of a latency impact function to provide a latency impact-oriented SLO-guaranteed system that enables a database system to support multi-tenant latency-impact targets in a cost-effective fashion. In contrast to traditional latency management based on percentile guarantees, the present invention manages latency based on the latency probability density function for all latency values. Cost-effective management is attained through latency impact-oriented capacity planning and real-time latency impact target enforcement. The capacity planning estimates the feasibility of latency-impact targets while the target enforcement tracks and regulates the per-connection query latency distribution needed for accurate latency-impact target guarantee, avoiding both under-provisioning and over-provisioning. The database service capacity can be fully exploited to efficiently accommodate tenants while minimizing resources required for latency-impact target guarantee.

### STATEMENT OF GOVERNMENTAL SUPPORT

This invention was made with government support under contract numbers CNS2008835 and CCF2226117 awarded by the National Science Foundation (NSF). The Government has certain rights in this invention.

### FIELD

The present invention relates to computer database management, in particular to the management of latency in multi-tenant databases on computer network and/or storage subsystems.

### BACKGROUND

Latency in the context of computer multi-tenant database systems is an important factor in the user experience, particularly with regard to query latency. Excessive latency can lead to user dissatisfaction with the Quality of Service (QoS) provided by a networked computer database system, and can lead to user drop-out, or “disengagement” from the system. This can have a severe impact on the economic viability of the system. In response to this situation, QoS efforts typically include automated real-time latency management schemes for provisioning of network and/or storage equipment to limit latency delay.

For a given latency (measured in time delay, such as 1200 ms including delays within a ±10 ms range) there is a measurable probability that a particular connection to a database system will exhibit a query latency of that delay. (This particular example of 1200 ms is chosen for purposes of illustration only and is not intended to be a representative example of actual latencies.)

There is also a cumulative probability that the connection will exhibit a latency less than or equal to a given delay. This cumulative probability is typically expressed in terms of a percentile of all latency delays, which is often chosen arbitrarily to be 95%-the “95th percentile”, for example, includes latency delays of any duration, except for the remaining 5% of delays that exceed the given delay. In the present example (above), having a 95th percentile of 1200 ms means that 95% of all latency delays will be less than or equal to 1200 ms. The remaining 5% of all queries exhibit delays greater than 1200 ms, including some queries that have a 1300 ms delay, and possibly even some queries that are never processed and thus have effectively an infinite delay.

Traditional QoS management for latency is percentile-based, where a specified delay is guaranteed to be at a specified percentile. In the present example, users would have a guaranteed 95th percentile latency of 1200 ms. Users of the database under this guarantee would be assured that 95% of their queries would be processed in 1200 ms or less.

In this traditional approach to latency management the cumulative probability is controlled at a single point—the arbitrarily chosen percentile. Unfortunately, this is not an optimal approach, because it ignores the high variability and dynamism of the workload that is inevitable in a consolidated multi-tenant database environment, and which can produce unexpected changes in the cumulative probability. The result is that controlling cumulative probability via percentile makes it difficult to accurately provision resources, resulting in more frequent under-provisioning (where an excessive number of queries take longer than the guaranteed delay) or over-provisioning (which is wasteful of resources).

In addition, users differ in their tolerance of latency delays-some are highly-sensitive to latency delays and expect low latency, whereas others may not be as sensitive to delays. Responding to differences in latency expectations further complicates traditional percentile-based latency control.

For these reasons, it would be highly desirable to have a method and configuration for managing latency based on controlling the entire latency distribution, rather than a single point of the cumulative distribution. This goal is attained by the present invention.

### SUMMARY

The term “database” herein denotes any collection of machine-accessible data, information, and/or knowledge contained in non-transitory data storage which may be of interest to users. Also included within the scope of the term database is any derivative data, information, and knowledge which may be produced by automated data processing systems, equipment, devices, and apparatus from stored data through operations including, but not limited to: searching, retrieving, analyzing, arranging, synthesizing, combining, selecting, extracting, copying, encrypting/decrypting, compressing, decompressing, discriminating, partitioning, sorting, extrapolating, comparing, scheduling and sequencing of operations, computing and performing mathematical operations, evaluating, translating, graphing, displaying, plotting, formatting, reformatting, transforming, and performing “artificial intelligence” (AI) operations. Thus, the term “database” as used herein is broad and not necessarily limited to systems that are formally labeled as “databases” or “database applications”.

Data processing apparatus includes, but is not limited to: computers, controllers, servers, routers, responders, repeaters, switches, data storage devices, readers and printers, and devices such as workstations, terminals, smartphones, and tablets.

The term “network” herein denotes any configuration of data processing systems, equipment, devices, and apparatus (“nodes”) having intercommunicating data connections (“links”) allowing interactions among the data processing systems, devices, and apparatus. Interactions include, but are not limited to: the transfer of data, requests for retrieval and transfer of data, configuring and reconfiguring network connections and topologies, requests for storage of data, requests for processing of data, and instructions for handling, processing, storage, and retrieval of data.

The present invention relates to data processing, storage, and retrieval systems, apparatus, and devices involving data networks having non-transitory database storage and/or access to non-transitory database storage. Data networks include, but are not limited to: Local Area Networks, Wide Area Networks, the Internet and portions thereof, private networks, Virtual Private Networks, Cloud Computing Networks; and networks capable of parallel processing, including parallel databases, and transaction processing. In addition, it is noted that networks typically offer data processing “resources” to users.

Network-based processing typically supports a multi-user capability, where different users have disjoint process spaces on the network, such that each user in a multi-user environment has completely separate data and data access from all other users. In a database environment, however, the different users-referred to as “tenants”, have some separate individual data and data access from all other tenants, but also share access to a common database. The term “multi-tenant database” herein denotes any such arrangement, even if the common database (as defined above) may not formally be labeled as a “database”.

According to embodiments of the present invention, there is provided a latency management system which is implemented in data processing system software, and provides services for a multi-tenant database. In one embodiment, the latency management system is a software module hosted within a data processing system; in another embodiment, the latency management system is distributed over a data/storage network.

The latency management system includes a capacity planner, which, in a related embodiment, runs in a background process on the data processing system. The capacity planner receives reports of current query throughput in the multi-tenant database, along with current latency statistics, and provides details on the current budgets for sustaining query throughput for each tenant. Concurrently, the capacity planner continually provides estimates of the system/storage/network resources needed to efficiently keep the query latencies for the various tenants within satisfactory limits. As part of this process, the capacity planner also provides an optimized schedule for handling tenant database queries.

After the capacity planner has set out the estimates of data processing system resources, along with the database query schedule, a latency target enforcer allocates resources for the multi-tenant database and organizes the queries into queues for execution. According to an embodiment of the present invention, there are two principal queues: a simple Round Robin scheduler for queries from low latency-sensitive (LLS) tenants, and an Earliest Deadline First (EDF) queue for queries from high latency-sensitive (HLS) tenants.

At the same time the management system is optimizing multi-tenant database resources to meet the target requirements of the tenants, the multi-tenant database itself continues processing the tenants' queries and reports its throughput, current latency, and service time statistics to the management system for budget enforcement.

### BRIEF DESCRIPTION OF THE DRAWING

The subject matter disclosed may best be understood by reference to the following detailed description when read with the accompanying drawing in which:

FIG. 1 is a block diagram showing the data structures, management resources, and general flow of control and data within a latency management system for a multi-tenant database, according to embodiments of the present invention.

For simplicity and clarity of illustration, elements shown in the FIGURE are not drawn to scale, and the dimensions of some elements may be exaggerated relative to other elements

### DETAILED DESCRIPTION

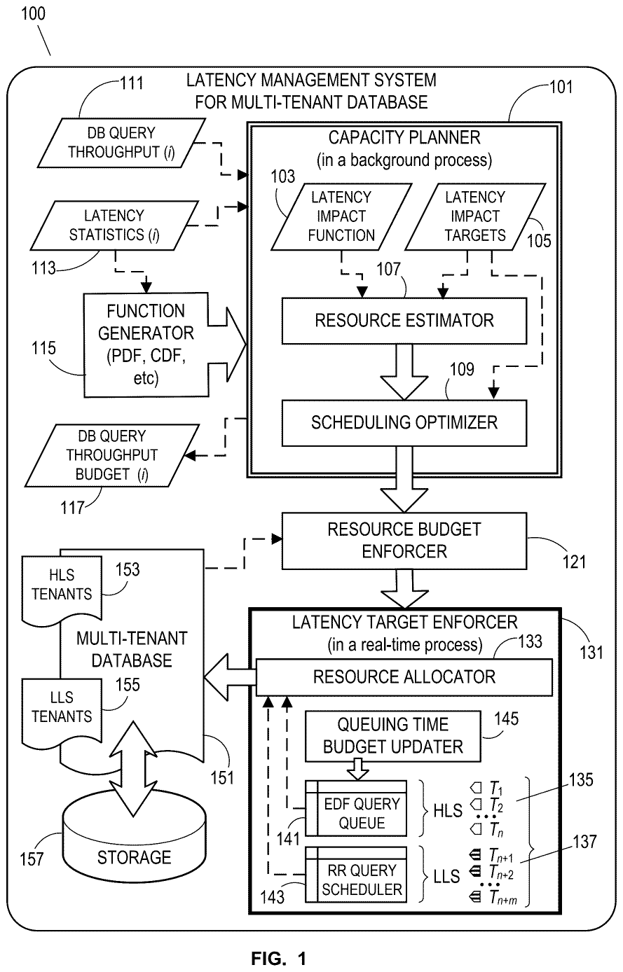

FIG. 1 is a block diagram showing the data structures, management resources, and general flow of control and data within a latency management system 100 for a multi-tenant database 151 supported by non-transitory data storage 157, according to embodiments of the present invention.

In an embodiment of the present invention, multi-tenant database 151 has n currently-connected tenants who are classified as having a high latency sensitivity (HLS), meaning that the negative impact of latency in the query process significantly affects them. HLS tenants are identified by an integer index i, where 1≤i≤n for the HLS tenants. In addition, multi-tenant database 151 also has m currently-connected tenants who are classified as having a low latency sensitivity (LLS), meaning that the negative impact of latency in the query process does not significantly affect them. LLS tenants are also identified by the integer index i where n+1≤i≤n+m for the LLS tenants.

Tenants are classified as HLS rather than LLS based on their predetermined preferences regarding a latency impact function 103, as described in a following section.

In the descriptions which follow, latency management system 100 and all components thereof can identify and access information and connections of specific individual tenants by using the value of index i.

In another embodiment of the present invention, multi-tenant database 151 has only HLS tenants, with no LLS tenants, and for this embodiment, references appearing below to LLS tenants and provisions for LLS tenants are not applicable.

Associated with multi-tenant database 151 are a list of HLS tenants 153 and a list of LLS tenants 155. In a related embodiment, list 153 and list 155 contain tenants who may not currently be connected to multi-tenant database 151.

In an embodiment of the present invention, multi-tenant database 151 is included within latency management system 100; in an alternate embodiment of the present invention, latency management system 100 has a connection to multi-tenant database 151.

In an embodiment of the present invention, latency management system 100 is a software module hosted within a data processing system. In another embodiment, latency management system 100 is distributed over a data network.

According to a further embodiment of the present invention, latency management system 100 includes a capacity planner 101 to determine the static configurations of the system's components under a given query latency variation and throughput provisioning. In a related embodiment, capacity planner 101 operates in a background process. Being in a process that runs in the background, capacity planner 101 can be considered as being “off-line” or running during idle cycles of low processor activity.

In these embodiments, capacity planner 101 includes latency impact function 103 and latency impact target values 105 for all HLS tenants. In a related embodiment, latency impact function 103 and latency impact target values 105 are provided in non-transitory data storage; in another embodiment, latency impact function 103 and latency impact target values 105 are provided as outputs of subroutines in non-transitory data storage. Outputs from latency impact function 103 and latency impact target 105 values are input to a resource estimator 107, which provides an estimate of the database resources needed to meet a latency target of impact targets 105. In an embodiment of the present invention, the estimates of resource estimator 107 are based on a probability density function (PDF) of query latency; and in a related embodiment, the estimates of resource estimator are based on a cumulative distribution function (CDF) of query latency. A scheduling optimizer 109 optimizes scheduling policies and scheduling parameters for real-time resource allocation, as also discussed below. In an embodiment of the present invention, scheduling optimizer 109 bases scheduling on a probability density function (PDF) of query latency; and in a related embodiment, scheduling optimizer 109 bases scheduling on a cumulative distribution function (CDF) of query latency.

According to embodiments of the invention, scheduling optimizer 109 optimizes the upper limit (D) for per-connection query bursts by finding an optimal throughput peak with the minimum D under the bounded concurrency (C). In this way, capacity planner 101 effectively maintains throughput with minimal slow-down on account of query latency peaks resulting from unregulated multi-tenant query patterns.

As noted above, tenants are classified as HLS rather than LLS based on their predetermined preferences regarding latency impact function 103. In an embodiment of the present invention, latency impact function 103 is a step function having a transition point from a first output value to a second output value. In this embodiment, the transition point denotes the maximum mean query latencies that the tenant prefers under different levels of latency variations within the possible range (i.e., mean latency budget, denoted as MLB), and each tenant's preferred MLB is included as that tenant's latency impact target value in latency impact target values 105. If a tenant decides not to specify a predetermined MLB for latency impact function 103, then there will be no entry for that tenant in impact targets 105, and in such a case, that particular tenant will be classified as LLS.

According to embodiments of the invention, each tenant's latency impact target is translated into multiple MLBs, representing the tenant's preferred maximum mean latencies. This is done under different levels of latency variations within the possible range. Thus, each MLB corresponds to a specific latency variance for the tenant's latency impact target. In this way, resource budget enforcer 121 effectively regulates connection-level query latency distributions according to the MLB under the current level of latency variation (which may be highly variable). Inputs to capacity planner 101 include:
database query throughput statistics 111 stored in non-transitory data storage, which provides details on the database query performance for any specified tenant (i);
latency statistics 113 stored in non-transitory data storage, which provides query latency history for any specified tenant (i); and
a function generator 115, which provides functions such as the latency probability density function (PDF) and its integral, the latency cumulative distribution function (CDF), as well as other functions, such as the digamma function y and its derivative, which are useful in estimating the mean under different variance of latency for determining a mean latency budget (MLB) for a specified tenant (i). It is noted that both the PDF and the CDF are functions over the entire latency domain, not just at an arbitrarily-chosen point. This is in contrast to specifying a percentile (such as the 95^{th} percentile), which is a single arbitrarily-chosen point. Instead, the latency cumulative distribution function (CDF) is a function extending over the entire latency domain, and has values for all latencies. In a related embodiment of the invention, function generator 115 is provided as a resource over the network.

Outputs from capacity planner 101 include:
a database query throughput resource budget 117 for any specified tenant (i); and
resource estimates from resource estimator 107; and optimized query schedules from scheduling optimizer 109 (including latency impact targets 105) to a resource budget enforcer 121, as described below. An optimized schedule contributes to maintaining a given high level of query throughput.

Resource budget enforcer 121 (as noted above) receives resource estimates, optimized query schedules, and latency impact targets. Based on these inputs, resource budget enforcer provides resource budgets to a latency target enforcer 131. The object of resource budget enforcer 121 is to dynamically track and regulate the latency distribution of each specific HLS tenant to accurately meet their individual latency targets.

According to a related embodiment of the present invention, latency target enforcer 131 runs in real-time, in an active process; it is thus considered to be a responsive, dynamic “on-line” service. Latency target enforcer 131 includes the following:
a resource allocator 133, which apportions data processing and storage resources to multi-tenant database 151;
   an earliest-deadline-first (EDF) query queue 141 for HLS tenants via HLS connections Tᵢ 135 to multi-tenant database 151, where 1≤i≤n, as noted previously;
   a round-robin (RR) query scheduler 143 for LLS tenants via LLS connections Tᵢ 137 to multi-tenant database 151, where n+1≤i≤n+m, as also noted previously; and
   a queuing time budget updater 145;
Classic round robin scheduling executes according to a time-sharing cyclic process. According to embodiments of the present invention, however, RR query scheduler 143 is enhanced for LLS tenants by handling queries on a query-quantum-based fair-share basis, whereby only those LLS tenant connections with a query quantum >0 can issue queries. In this way, query latency variation can be effectively controlled to reduce the effects of HLS tenants' latency impact target enforcement.

Regarding EDF query queue 141, which contains current queries-to-be-processed from HLS tenants, the query time budget for HLS connection Tᵢ indicates the maximum time the query can stay in queue 141, and queuing time budget updater 145 not only updates this time limit, but also sorts and resorts the entries in the queue as necessary, with their upcoming deadlines in ascending order so that the query with the earliest deadline will be the next query popped off the queue for processing.

Regarding RR query scheduler 143, which contains current queries-to-be-processed from LLS tenants, the queries are handled in a query-quantum-based fair-share manner, sometimes referred to as a “round robin” (RR) priority arrangement. Because the LLS connections are characterized by not having latency restrictions, this simple scheduler is normally sufficient to support high-level query fairness and efficiency. In other embodiments of the present invention, however, the order of entries in RR query scheduler 143 is adjusted by queuing time budget updater 145 according to alternative scheduling and resource availability policies.

What is claimed is:

1. A latency management system for a multi-tenant database, the latency management system comprising:
a connection to the multi-tenant database;
a list of high latency sensitivity tenants of the multi-tenant database
a capacity planner operative to determine respective static configurations of a system component under a current query having a latency variation, and to estimate throughput provisioning and optimal scheduling for the current query, wherein the capacity planner includes a latency target;
a resource estimator operative to estimate a database resource for meeting the latency target, wherein a database resource estimate thereof is based on at least one of:
a latency probability density function (PDF), and
a latency cumulative distribution function (CDF);
a resource budget enforcer operative to receive the database resource estimate, a query schedule, and a latency impact target; and
to provide a resource budget therefor; and
a latency target enforcer operative to regulate a latency distribution of a high latency sensitivity (HLS) tenant to meet a latency target of the HLS tenant.

2. The latency management system of claim 1, further comprising:
database query throughput statistics on database query performance for a tenant;
latency statistics on query latency history for a tenant; and
a function generator operative to provide at least one of:
a latency probability density function (PDF), and
a latency cumulative distribution function (CDF).

3. The latency management system of claim 2, wherein the throughput provisioning includes a database query throughput resource budget for a tenant.

4. The latency management system of claim 2, wherein the capacity planner further comprises a scheduling optimizer operative to maintain a given level of query throughput, wherein the scheduling optimizer bases scheduling on at least one of: a latency probability density function (PDF), and a latency cumulative distribution function (CDF).

5. The latency management system of claim 1, wherein the latency target enforcer comprises:
a resource allocator operative to apportion data processing and storage resources to the multi-tenant database;
an earliest deadline first (EDF) query queue;
a queuing time budget updater operative to sort a query entry in the EDF query queue according to a deadline of the entry, in an ascending order.

6. The latency management system of claim 5, wherein the latency target enforcer further comprises:
a round robin (RR) query queue for a query from a low latency sensitivity (LLS) connection to the multi-tenant database.
